(19) United States
(12) Patent Application Publication
(10) Pub. No.: US 2012/0034045 A1
(43) Pub. Date: Feb. 9, 2012

(54) Temporary Rivet

(75) Inventor: Ralph Luhm, La Habra Heights, CA (US)

(73) Assignee: ALLFAST FASTENING SYSTEMS, INC., City of Industry, CA (US)

(21) Appl. No.: 12/851,985

(22) Filed: Aug. 6, 2010

(51) Int. Cl. F16B 19/04; B21J 15/02

(52) U.S. Cl. 411/360; 29/525.06

(57) ABSTRACT

A temporary fastener or temporary blind rivet having a cylindrical sleeve and a sleeve head thereon, the region where the sleeve and sleeve head mate having a plurality of local protrusions thereon, with a stem passing through the sleeve head and sleeve, the stem having an enlarged stem head thereon adjacent the end of the sleeve opposite the sleeve head, the stem for pulling relative to the sleeve head to cause the enlarged stem head to form a blind side head on the sleeve, to pull the workpieces together, to cause the local protrusions to make depressions in, and to fill the depressions in, an outer edge of the hole in the adjacent workpiece, and to pull through the sleeve and sleeve head to expand the sleeve into a tight fit in the hole in the workpieces. The protrusions make indentations in the edge of the hole in the adjacent workpiece to provide increased resistance to spinning when the temporary blind rivet is drilled out for a permanent fastener.

### BACKGROUND OF THE INVENTION

1. Field of the Invention

This invention relates to the field of metal rivets, and more particularly, temporary blind rivets.

2. Prior Art

U.S. Reissue Pat. No. 38,664 discloses a method for creating a hole for a permanent fastener that replaces a tacking fastener (temporary rivet). The tacking fastener preferably used with respect to that method is a blind tacking fastener having a number of features, not all of which must be used to achieve at least some of the desired objectives. In particular, in a preferred form the temporary fastener has a head with an outer diameter which is less than the diameter of the drill 34 which will be used to drill out the temporary fastener and create a hole in the workpieces for a permanent fastener. This avoids having rings cut from temporary fastener heads that are larger than the shank of the permanent fastener when drilling out for the final fastener, which rings tended to build up on the drill and generally are not easily removed.

Also the preferred temporary fastener has a tapered head. While the tapered head is not countersunk into the workpiece, the taper preferably has an angle selected so that the drill used for forming the hole for the final fastener will remove the entire head before starting to drill through the workpieces. An alternative approach that has been used by Cherry Aerospace LLC is to use a temporary fastener head that on installation, will sit flat against the outer workpiece, though this has the disadvantage of leaving a ring of head material when the drill bit separates the head from the sleeve of the temporary fastener, which ring then spins with the drill bit to prevent further penetration thereof. This can also result in drill bit wander, resulting in undesired heavy scratching of the outer workpiece. Generally the outer surface of the head, no matter how the head is configured, preferably has a central depression for initial location (centering) of the drill bit before drilling begins.

The temporary fastener in accordance with the foregoing patent did not include a special provision to prevent spinning of the fastener sleeve in the workpiece when being drilled out for the permanent fastener. In general, it was found that the friction caused by the head formed at the blind end of the sleeve, together with the expansion of the sleeve against the temporary hole in the workpieces caused by the pulling of the stem through the sleeve during setting of the temporary fastener, provided adequate friction for a reasonably sharp drill to drill away the head of the fastener and then drill through the workpieces and sleeve to form the hole for the permanent fastener. Still there is the possibility that a dull but still functional drill, perhaps also with a slightly oversize hole for the temporary fastener, could result in a spinner, so to speak, while drilling through the temporary fastener head, thereby preventing the further progression of the drill. However Allfast Fastening Systems, Inc., the assignee of the present invention and of the reissue patent referred to above, has not had complaints about temporary fasteners in accordance with the patent spinning in response to the drilling, interfering with a successful drilling operation. Of course once the head is removed by the drill for the final hole, any spinning of the remaining sleeve in the hole for the temporary fastener is of no consequence, as even though such spinning prevents the drilling out of the remaining portion of the sleeve, the remaining portion of the sleeve will simply be pushed out from the backside of the workpieces by the progression of the drill.

At one time, Cherry Aerospace LLC produced a temporary fastener for such use, which fastener had a head which generally set flat against the workpiece, which as previously described would result in a ring being cut free from the base of the head, which unless a sharp drill could cut therethrough, would simply spin, preventing further progression of the drill. Also, a spinning of the entire sleeve and head of a set temporary fastener of this general type may have been encountered, as the particular product marketed used a sleeve having a splined outer diameter, apparently intended to prevent or at least resist such spinning. However, when such a temporary fastener is set and then the workpiece sectioned to see the effect of the spline, it is found that because the hardness of the workpieces generally is greater than the hardness of the sleeve, the splines do not bite into the workpieces, so to speak, but rather yield and flatten, thereby giving little increased resistance to spinning.

### BRIEF DESCRIPTION OF THE DRAWINGS

FIG. 1 illustrates a temporary rivet in accordance with a preferred embodiment of the present invention.

FIG. 2 illustrates the installation of the temporary rivet of FIG. 1 to hold two workpieces together.

FIG. 3 illustrates the setting of the temporary rivet of FIGS. 1 and 2 by the pulling on the stem relative to the sleeve head.

FIG. 4 is a partial cutaway view of part of FIG. 3.

FIG. 5 illustrates the centering of the drill and the beginning of drilling out the temporary rivet.

FIG. 6 illustrates the progressive removal of the entire head of the temporary rivet when forming the hole for a permanent fastener.

FIGS. 7 and 8 present pictures of a temporary rivet sleeve.

### DETAILED DESCRIPTION OF THE PREFERRED EMBODIMENTS

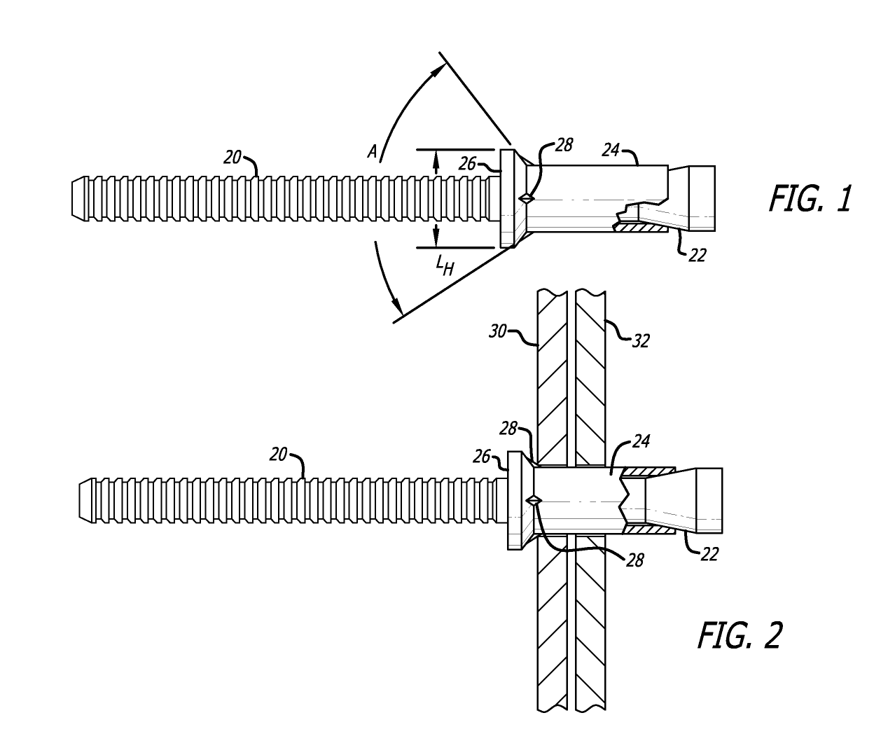

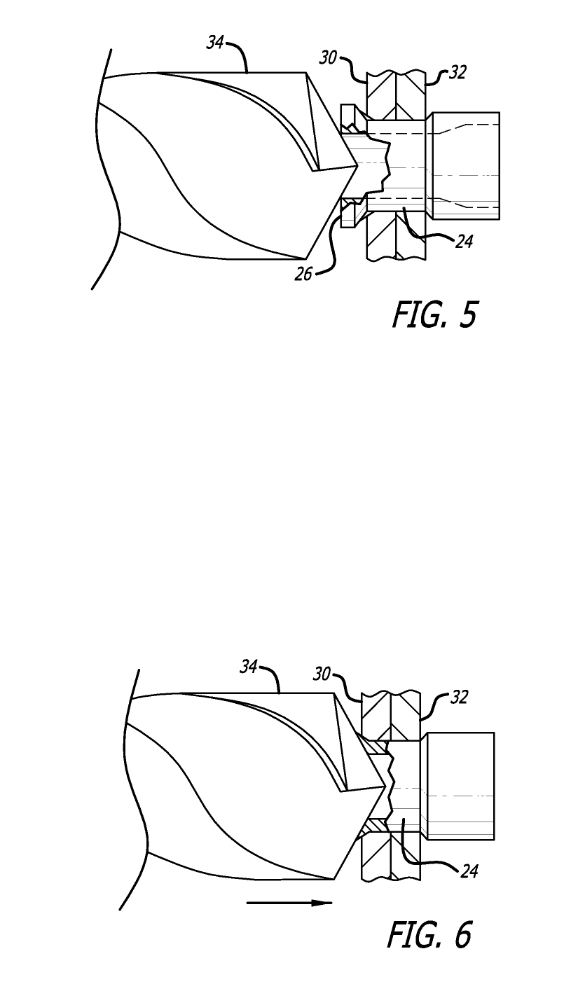

First referring to FIG. 1, a temporary rivet in accordance with a preferred embodiment of the present invention may be seen. The temporary rivet is comprised of a pulling stem 20 with a tapered and enlarged head 22 thereon, within a sleeve 24 having a head 26 thereon. The sleeve side of the head 26 is tapered at an included angle A that is purposely made smaller than the included angle on the end of the drill which will be used to later drill out the temporary rivet to form the hole for the permanent fastener (FIGS. 5 and 6). Similarly, the diameter L_{H} of the head 26 is purposely made smaller than the diameter of the drill which will later be used to form the hole in the workpieces for the permanent fastener (FIGS. 5 and 6 again). This structure as just described is in accordance with the preferred embodiment of the prior art patent hereinbefore referred to. However, in addition, the temporary rivet of FIG. 1 includes projections or ribs 28 in the region of the intersection of the tapered of head 26 and the sleeve 24. These projections are preferably diamond shaped with sloped sides rising to a peak at the center of each rib, though other shapes may be used if desired.

FIG. 2 illustrates the installation of the temporary rivet to hold two workpieces 30 and 32 together. The temporary rivet is easily inserted into the hole in the workpieces for the temporary rivet, at which time the workpieces may be somewhat separated, as shown in FIG. 2. Also the temporary rivet is prevented from being inserted quite as far into workpiece 30 as a prior art temporary rivet because of the engagement of ribs 28 on the outer edge of the hole in workpiece 30.

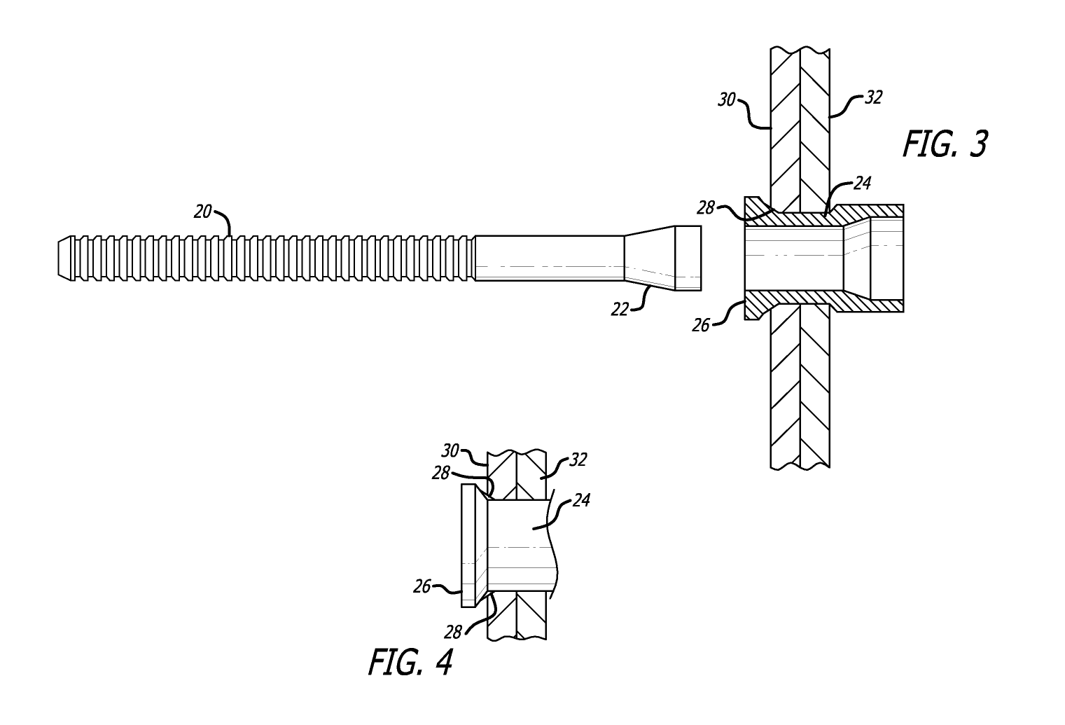

FIG. 3 illustrates the setting of the temporary rivet of FIGS. 1 and 2 by the pulling on the stem 20 relative to the sleeve head 26, and FIG. 4 is a partial cutaway view of part of FIG. 3. The enlarged head 22 of the stem 20 flares the blind side of the sleeve 24 outward as shown, with the progressive expansion of the blind side end of sleeve 24 pulling the workpieces 30 and 32 together and providing sufficient axial force to pull the ribs or protrusions 28 against the outer edges of the hole in workpiece 30 to deform the same. Thus at least part of the protrusions 28 form a mechanical lock with respect to rotation of the sleeve relative to workpiece 30. In that regard, it should be noted that the sleeve material, typically 5056 or 2017, is considerably softer than the workpiece material, typically 2024 or 7075, yet the ribs 28, while being deformed during the setting of the temporary rivet, also deform the outer edge of the hole in workpiece 30 to make definite impressions therein, and to fill the deformations to become solid obstacles to the spinning of the set fastener in the workpieces, at least until the head 26 and the ribs 28 extending into the depressions in the outer edge of the hole in the workpiece 30 are drilled out, after which spinning doesn't matter.

Once the temporary rivet is set, a drill is used to drill out the sleeve head, the sleeve and the hole itself, removing the depressions in the edge of the hole in workpiece 30 in forming the hole for the permanent fastener. Note that if a tapered sleeve head is used, then essentially the entire head will be removed by the drill before the drill reaches the workpiece, as illustrated in FIG. 6. To the extent that a thin edge of the sleeve head formed during the drilling rolls toward the workpiece 30 rather than being cut, such edge will have no structural integrity, and is easily cut by the drill once the drill reaches the workpiece 30.

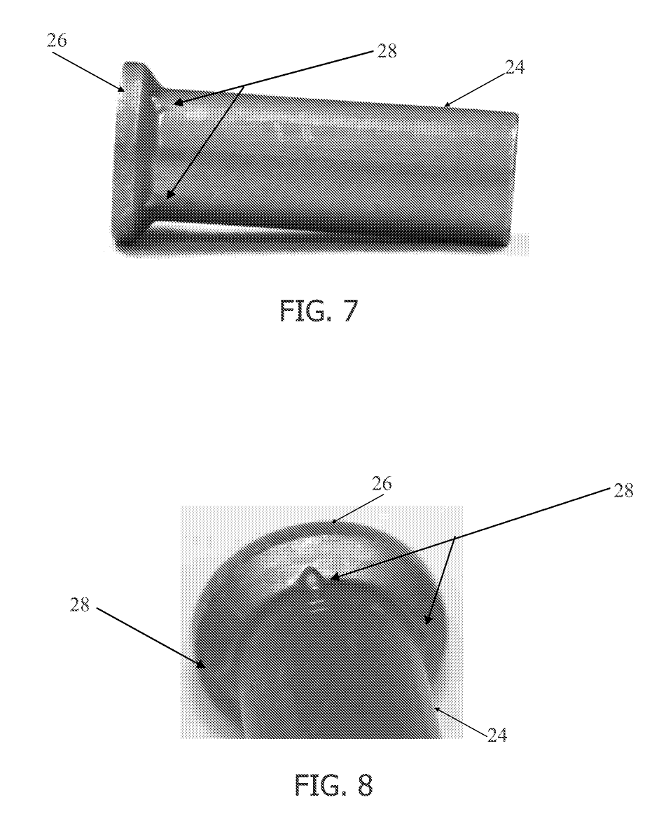

Now referring to FIGS. 7 and 8, pictures of a temporary rivet sleeve 24 with head 26 and ribs 28 thereon may be seen. In a preferred embodiment, four such ribs are used, distributed at 90 degree increments, though a lesser number or greater number of ribs may be used. Too many ribs 28, however, may prevent the ribs from deforming and extending into the material of the workpiece around the outer edges of the hole in the workpiece, whereas too few may not provide the desired resistance to spinning. Four such ribs at 90 degree increments was selected in the preferred embodiment because of its adequate penetration into the edge of the hole in the workpiece during setting of the temporary rivet, while at the same time providing at least the desired extent of resistance to spinning.

In the preferred embodiment, as described, the sleeve side of the head 26 is tapered at an included angle A that is purposely made smaller than the included angle on the end of the drill which will be used to later drill out the temporary rivet to form the hole for the permanent fastener. This allows the sleeve head to be drilled away without separating any significant ring that can spin with the drill. However, the head shape used is optional, as the present invention helps prevent spinning of the set temporary rivet, in spite dull drills and any tendency of a drill bit to catch and bite into the sleeve head.

Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A temporary blind rivet comprising:
a cylindrical sleeve for insertion into a hole in workpieces, the sleeve having a sleeve head thereon, the region where the sleeve and sleeve head mate having a plurality of local protrusions thereon;
a stem passing through the sleeve head and sleeve, the stem having an enlarged stem head thereon adjacent the end of the sleeve opposite the sleeve head, the stem for pulling relative to the sleeve head to cause the enlarged stem head to form a blind side head on the sleeve, to pull the workpieces together, to cause the local protrusions to make depressions in, and to fill the depressions, in an outer edge of the hole in the adjacent workpiece, and to pull through the sleeve and sleeve head to expand the sleeve into a tight fit in the hole in the workpieces.

2. The temporary blind rivet of claim 1 wherein, except for the local protrusions, the sleeve head is tapered outward from it junction with the cylindrical sleeve.

3. The temporary blind rivet of claim 2 wherein the included angle of the taper is less than the included angle of the drill that will be used to drill out the temporary blind rivet.

4. The temporary rivet of claim 1 wherein the number of local protrusions is 4.

5. The temporary rivet of claim 4 wherein the local protrusions are distributed around the sleeve in 90 degree increments.

6. A method of temporarily joining a first workpiece and a second workpiece and replacing the temporary rivet with a permanent rivet to permanently join the workpieces, comprising:
providing a temporary rivet including;
a cylindrical sleeve having a sleeve head thereon, the region where the sleeve and sleeve head mate having a plurality of local protrusions thereon; and
a stem passing through the sleeve and having an enlarged stem head thereon adjacent the end of the sleeve opposite the sleeve head;
drilling a hole through the first and second workpieces for the temporary rivet;
placing the temporary rivet in the hole for the temporary rivet in the first and second workpieces with the enlarged stem head and adjacent end of the sleeve extending through the hole in the first and second workpieces;
with the plurality of local protrusions against an outer edge of the hole in the first workpiece, pulling the stem relative to the sleeve head to cause the enlarged stem head to form a blind side head on the sleeve, to pull the workpieces together, to cause the local protrusions to make depressions in, and to fill the depressions in, the outer edge of the hole in the first workpiece;
engaging a drill bit where the stem passed through the sleeve head, the drill bit having a diameter larger than the sleeve head diameter;
drilling the sleeve head, the sleeve, the first workpiece, and the second workpiece to remove the sleeve head, the sleeve and the depressions in the outer edge of the hole in the first workpiece to form a hole in the first and second workpieces for the permanent rivet; and
installing the permanent rivet.

7. The method of claim 6 wherein the sleeve is softer than the first workpiece.

8. The method of claim 6 wherein the sleeve head has a tapered side adjacent the cylindrical sleeve.

9. The method of claim 8 wherein the tapered side of the sleeve head has an included angle that is less than the included angle of the drill bit.
